(19) United States
(12) Patent Application Publication
(10) Pub. No.: US 2026/0124955 A1
(43) Pub. Date: May 7, 2026

(54) ELECTRIC VEHICLE AND A METHOD FOR PREDICTING A STATE-OF-CHARGE OF AN AUXILIARY BATTERY OF AN ELECTRIC VEHICLE

(71) Applicants: HYUNDAI MOTOR COMPANY, Seoul (KR); KIA CORPORATION, Seoul (KR)

(72) Inventors: Xiu Kun Li, Yantai (CN); Jin Zhao Lin, Yantai (CN); Liu Yi Ren, Yantai (CN)

(73) Assignees: HYUNDAI MOTOR COMPANY, Seoul (KR); KIA CORPORATION, Seoul (KR)

(21) Appl. No.: 19/381,988

(22) Filed: Nov. 6, 2025

(30) Foreign Application Priority Data
Nov. 7, 2024 (CN) 202411585412.6

(51) Int. Cl. B60L 58/12; B60L 1/00; B60L 58/18; G07C 5/08

(52) U.S. Cl. CPC B60L 58/12; B60L 1/00; B60L 58/18; G07C 5/0808; B60L 2240/662

(57) ABSTRACT

An electric vehicle includes a main battery, an auxiliary battery, a power load, a power converter, a switch, a memory, and a controller. The controller controls the switch. When the switch is turned on, the low voltage power converted in the power converter is provided to the auxiliary battery thereby charging the auxiliary battery, and when the switch is turned off, the auxiliary battery is discharged. When the auxiliary battery is charged after the vehicle is turned off, the controller obtains the output current value of the power converter. The controller determines the state-of-charge (SOC) of the auxiliary battery based on the obtained output current value of the power converter, based on a correspondence relationship between an output current value of the power converter and an SOC of the auxiliary battery at the time when the auxiliary battery is charged after the vehicle is turned off.

### CROSS-REFERENCE TO RELATED APPLICATION

This application claims priority to and the benefit of Chinese Patent Application No. 202411585412.6 filed with the Chinese National Intellectual Property Administration on Nov. 7, 2024, the entire contents of which are incorporated herein by reference.

### TECHNICAL FIELD

The present disclosure relates to an electric vehicle and a method for predicting a state-of-charge of an auxiliary battery of an electric vehicle.

### BACKGROUND

Conventional electric vehicles (EV) use an intelligent battery sensor (IBS) mounted on the EV to monitor the status of the 12V auxiliary battery in real time. The IBS transmits a state-of-charge (SOC), a state-of-function (SOF), a state-of-health (SOH), or the like, of the monitored auxiliary battery to a vehicle control unit (VCU) through an in-vehicle local interconnect network (LIN). The VCU determines whether to charge the auxiliary battery based on the SOC of the auxiliary battery. For example, when the SOC of the auxiliary battery is smaller than or equal to 80%, the VCU may determine that the auxiliary battery needs to be charged. At this time, a low-voltage DC (direct current)-DC converter (LDC) converts a high voltage power of a high pressure battery (e.g., main battery) of the vehicle into a low voltage power, and provides the converted low voltage power to the auxiliary battery.

In an internal combustion engine (ICE) vehicle, the IBS plays an important role in improving cold cranking efficiency and fuel efficiency. Compared to ICE vehicles, EVs do not require mechanical structures such as engine generators and Idle Stop & Go (ISG) functions, and do not need to consider the features of the cold cranking efficiency and fuel efficiency. In addition, even if the auxiliary battery is located within the engine compartment, the ambient temperature cannot exceed 80° C., and the state of the battery is not affected by environmental conditions. Therefore, for EVs, the importance of the IBS's function to predict the battery temperature model (BTM) and SOF is reduced. Therefore, in summary, the IBS is only needed in EVs when charging auxiliary batteries.

Since the IBS in EVs only works when charging the auxiliary battery, and the cost of EVs increases by mounting the IBS, there is a need to provide an EV and a method used for the EV that can predict the SOC of the auxiliary battery even without installing the IBS, and which does not affect the charging of the auxiliary battery.

The above information disclosed in this Background section is only to enhance understanding of the background of the disclosure. Therefore, the Background section may contain information that does not form the prior art that is already known in this country to a person of ordinary skill in the art.

### SUMMARY

The present disclosure provides an electric vehicle and a method for predicting a state-of-charge (SOC) of an auxiliary battery of an electric vehicle capable of predicting an SOC of an auxiliary battery without an intelligent battery sensor (IBS).

An electric vehicle includes a main battery, an auxiliary battery, a power load, a power converter, a switch, a memory, and a controller. The power converter is electrically connected between the main battery and the auxiliary battery, and configured to convert a first voltage power (e.g., a high voltage power) outputted from the main battery into a second voltage power (e.g., a low voltage power). The switch is electrically connected between the power converter and the auxiliary battery, and configured such that, when the switch is turned on, the auxiliary battery is charged as the second voltage power converted in the power converter may be provided to the auxiliary battery and an operating power load, and when the switch is turned off, the auxiliary battery is discharged in order to provide electric power to the operating power load. The memory may be configured to store a current consumption value of the power load operating after the vehicle is turned off and a correspondence relationship between an output current value of the power converter and an SOC of the auxiliary battery at the time when the auxiliary battery is charged after the electric vehicle (hereinafter also simply referred to as “vehicle”) is turned off. The controller may be configured to control the switch (e.g., turning on or off of the switch) after the vehicle is turned off in order to control charging of the auxiliary battery, obtain the output current value of the power converter, when the auxiliary battery is charged after the vehicle is turned off, and determine the SOC of the auxiliary battery after the vehicle is turned off, based on the obtained output current value of the power converter, according to (or based on) the correspondence relationship stored in the memory.

The controller may be configured to continuously charge the auxiliary battery, by maintaining the switch to be turned on after the vehicle is turned on.

The controller may be configured to control the switch to be turned on according to or based on an elapsed time, and control turning off of the switch according to or based on a calculated charging current value of the auxiliary battery or a predicted SOC of the auxiliary battery. The charging current value of the auxiliary battery may be equal to a difference value between the output current value of the power converter obtained in real time when the auxiliary battery is charged after the vehicle is turned off and the current consumption value of the power load operating after the vehicle is turned off that is stored in the memory.

The controller may be further configured to: control the switch to be turned on when a first reference time has elapsed after the vehicle is turned off; control the switch to be turned off when the predicted SOC of the auxiliary battery is greater than or equal to a reference power threshold value, or when the calculated charging current value of the auxiliary battery is smaller than a reference current threshold value (or based on the predicted SOC of the auxiliary battery being greater than or equal to a reference power threshold value, or based on the calculated charging current value of the auxiliary battery being smaller than a reference current threshold value); control the switch to be turned on at a second reference time interval, after controlling the switch to be turned off; and control the switch to be turned off, when the predicted SOC of the auxiliary battery is greater than or equal to the reference power threshold value, or when the calculated charging current value of the auxiliary battery is smaller than the reference current threshold value (or based on the predicted SOC of the auxiliary battery being greater than or equal to the reference power threshold value, or based on the calculated charging current value of the auxiliary battery being smaller than the reference current threshold value).

The current consumption value of the power load operating after the vehicle is turned off stored in the memory can be calculated through a test or

$${I}_{A} = \frac{{\sum }_{i = 1}^{n} ( {I}_{{C}_{i}} - {I}_{{B}_{i}} )}{n} , \qquad Equation$$

where, I_{A} is the current consumption value of the power load operating after the vehicle is turned off that is stored in the memory, I_{C}_{ᵢ} is the output current value of the power converter in an i-th test, I_{B}_{ᵢ} is a charging current value of the auxiliary battery in the i-th test, and n is the number of times of tests, and where, in the test, the second voltage power converted in or by the power converter after the vehicle is turned off may be provided to the auxiliary battery and the operating power load.

The correspondence relationship may be a mapping curve corresponding to a first mapping table, and the first mapping table may represent a mapping relationship between the output current value of the power converter, and the SOC of the auxiliary battery and an ambient temperature, at a specific charging time point of the auxiliary battery at the time when the auxiliary battery is charged after the vehicle is turned off (or based on the auxiliary battery being charged after the electric vehicle is turned off). The electric vehicle may further include an ambient temperature sensor configured to detect the ambient temperature outside the vehicle at each specific charging time point of charging the auxiliary battery. The controller may be further configured to determine the SOC of the auxiliary battery on the mapping curve, based on the ambient temperature detected by the ambient temperature sensor at each specific charging time point of charging the auxiliary battery and when the auxiliary battery is charged after the vehicle is turned off (or based on the auxiliary battery being charged after the electric vehicle is turned off), the output current value of the power converter obtained at each specific charging time point of charging the auxiliary battery.

The output current value of the power converter at the specific charging time point of the auxiliary battery when the auxiliary battery is charged after the vehicle is turned off (or based on based on the auxiliary battery being charged after the electric vehicle is turned off) in the first mapping table may be obtained by adding the charging current value at the specific charging time point of the auxiliary battery at the same SOC of the auxiliary battery and the same ambient temperature in a second mapping table, and the current consumption value of the power load operating after the vehicle is turned off stored in the memory. The second mapping table may represent a mapping relationship between the charging current value, and the SOC of the auxiliary battery and the ambient temperature at the specific charging time point of the auxiliary battery.

In the second mapping table, a range of the SOC of the auxiliary battery may be a predetermined first SOC value to a predetermined second SOC value (e.g., the SOC of the auxiliary battery may be in a range of 40% to 90%), a range of the ambient temperature may be a predetermined first ambient temperature value to a predetermined second ambient temperature value (e.g., the ambient temperature may be in a range of −20° C. to 25° C.), and a range of the specific charging time may be a predetermined first charging time value to a predetermined second charging time value (e.g., a range of the specific charging time may be 5 min to 30 min).

The controller may be configured to set a dark current amount to be 0, after the vehicle is turned off, to obtain a difference value between values of the SOC of the auxiliary battery predicted twice consecutively (e.g., to calculate a difference value of the SOC of the auxiliary battery predicted twice consecutively through the Equation: D=SOCₘ₋₁−SOCₘ, where, D is a difference value, SOCₘ₋₁ is a previously predicted SOC of the auxiliary battery, SOCₘ is a currently predicted SOC of the auxiliary battery, and m is an integer greater than or equal to 2), to determine whether the difference value is greater than or equal to a reference value, increase the dark current amount by 1 when it is determined that the difference value greater than or equal to the reference value (or based on determining that the difference value is greater than or equal to the reference value), and maintain the dark current amount not to vary when it is determined that the difference value is smaller than the reference value (or based on determining that the difference value is smaller than the reference value), and to determine that a dark current problem has occurred, when the accumulate dark current amount is greater than or equal to a reference dark current amount threshold value (or based on an accumulated dark current amount being greater than or equal to a reference dark current amount threshold value).

The controller may be configured to generate and transmit a diagnostic trouble code, when it is determined that the dark current problem has occurred.

A method for predicting a state-of-charge of an auxiliary battery of an electric vehicle including a main battery, the auxiliary battery, a power converter being electrically connected between the main battery and the auxiliary battery, a switch being electrically connected between the power converter and the auxiliary battery, a memory, and a controller includes: controlling, by the controller, charging of the auxiliary battery, by control turning on or off of the switch, after the vehicle is turned off; storing, by the memory, a current consumption value of a power load operating after the vehicle is turned off and a correspondence relationship between an output current value of the power converter and an SOC of the auxiliary battery, at the time when the auxiliary battery is charged after the vehicle is turned off (or based on the auxiliary battery being charged after the electric vehicle is turned off); obtaining, by the controller, the output current value of the power converter when the auxiliary battery is charged after the vehicle is turned off (or based on the auxiliary battery being charged after the electric vehicle is turned off); and determining, by the controller, the SOC of the auxiliary battery after the vehicle is turned off, based on the obtained the output current value of the power converter, according to (or based on) the correspondence relationship stored in the memory.

The method may further include continuously charging the auxiliary battery by maintaining the switch to be turned on, by the controller, after turning of the vehicle.

Controlling, by the controller, the switch (e.g., the turning on or off of the switch) after the vehicle is turned off may include controlling the switch to be turned on according to (or based on) an elapsed time, and controlling turning off of the switch according to (or based on) a calculated charging current value of the auxiliary battery or a predicted SOC of the auxiliary battery. The calculated charging current value of the auxiliary battery may be equal to a difference value between the output current value of the power converter obtained in real time when the auxiliary battery is charged after the vehicle is turned off and the current consumption value of the power load operating after the vehicle is turned off that is stored in the memory.

Controlling, by the controller, the switch (e.g., the turning on or off of the switch) after the vehicle is turned off may further include controlling, by the controller, the switch to be turned on when a first reference time has elapsed after the vehicle is turned off (or based on a first reference time having elapsed after the electric vehicle is turned off), controlling, by the controller, the switch to be turned off when the predicted SOC of the auxiliary battery is greater than or equal to a reference power threshold value (or based on the predicted SOC of the auxiliary battery being greater than or equal to a reference power threshold value), or when the calculated charging current value of the auxiliary battery is smaller than a reference current threshold value (or based on the calculated charging current value of the auxiliary battery being smaller than a reference current threshold value), and controlling, by the controller, the switch to be turned on at a second reference time interval, after controlling the switch to be turned off, and controlling, by the controller, the switch to be turned off, when the predicted SOC of the auxiliary battery is greater than or equal to the reference power threshold value (or based on the predicted SOC of the auxiliary battery being greater than or equal to the reference power threshold value), or the calculated charging current value of the auxiliary battery is smaller than the reference current threshold value (or based on the calculated charging current value of the auxiliary battery being smaller than the reference current threshold value, by the controller).

The current consumption value of the power load operating after the vehicle is turned off stored in the memory is calculated through a test or the Equation below,

$${I}_{A} = \frac{{\sum }_{i = 1}^{n} ( {I}_{{C}_{i}} - {I}_{{B}_{i}} )}{n}$$

where, I_{A} is the current consumption value of the power load operating after the vehicle is turned off that is stored in the memory, and I_{C}_{ᵢ} is the output current value of the power converter in an i-th test, and I_{B}_{ᵢ} is a charging current value of the auxiliary battery in the i-th test, and n is the number of times of tests. In the test, a low voltage power converted in or by the power converter after the vehicle is turned off may be provided to the auxiliary battery and the operating power load.

The correspondence relationship may be a mapping curve corresponding to a first mapping table, the first mapping table may represent a mapping relationship between the output current value of the power converter, and the SOC of the auxiliary battery and an ambient temperature, at a specific charging time point of the auxiliary battery when the auxiliary battery is charged after the vehicle is turned off (or based on the auxiliary battery being charged after the electric vehicle is turned off). The electric vehicle may further include an ambient temperature sensor. The method may further include detecting, by the ambient temperature sensor, the ambient temperature outside the vehicle at each specific charging time point of charging the auxiliary battery, and determining, by the controller, the SOC of the auxiliary battery on the mapping curve, based on the ambient temperature detected by the ambient temperature sensor at each specific charging time point of charging the auxiliary battery and when the auxiliary battery is charged after the vehicle is turned off (or based on the auxiliary battery being charged after the electric vehicle is turned off), the output current value of the power converter obtained at each specific charging time point of charging the auxiliary battery, by the controller.

The output current value of the power converter at the specific charging time point of the auxiliary battery when the auxiliary battery is charged after the vehicle is turned off (or based on the auxiliary battery being charged after the electric vehicle is turned off) in the first mapping table may be obtained by adding the charging current value at the specific charging time point of the auxiliary battery at the same SOC of the auxiliary battery and the same ambient temperature in a second mapping table, and the current consumption value of the power load operating after the vehicle is turned off stored in the memory. The second mapping table may represent a mapping relationship between the charging current value, and the SOC of the auxiliary battery and the ambient temperature, at the specific charging time point of the auxiliary battery.

In the second mapping table, a range of the SOC of the auxiliary battery may be a predetermined first SOC value to a predetermined second SOC value (e.g., the SOC of the auxiliary battery may be in a range of 40% to 90%), a range of the ambient temperature may be a predetermined first ambient temperature value to a predetermined second ambient temperature value (e.g., the ambient temperature may be in a range of −20° C. to 25° C.), and a range of the specific charging time is a predetermined first charging time value to a predetermined second charging time value (e.g., a range of the specific charging time may be 5 min to 30 min).

The method may further include: setting, by the controller, a dark current amount to be 0, after the vehicle is turned off; calculating (or determining or obtaining), by the controller, a difference value between values of the SOC of the auxiliary battery predicted twice consecutively (e.g., through the Equation: D=SOCₘ₋₁−SOCₘ, where, D is a difference value, SOCₘ₋₁ is a previously predicted SOC of the auxiliary battery, SOCₘ is a currently predicted SOC of the auxiliary battery, and m is an integer greater than or equal to 2); determining, by the controller, whether the difference value is greater than or equal to a reference value; increasing, by the controller, the dark current amount by 1 when it is determined that the difference value greater than or equal to the reference value (or based on determining that the difference value is greater than or equal to the reference value); maintaining, by the controller, the dark current amount not to vary when it is determined that the difference value is smaller than the reference value (or based on determining that the difference value is smaller than the reference value); and determining, by the controller, that a dark current problem has occurred when the accumulated dark current amount is greater than or equal to reference dark current amount threshold value (or based on an accumulated dark current amount being greater than or equal to reference dark current amount threshold value).

The method may further include generating and transmitting a diagnostic trouble code, by the controller, when it is determined that the dark current problem has occurred (or based on determining that the dark current problem has occurred).

The present disclosure uses the technical solution and has following beneficial effects.

An embodiment can predict an SOC of an auxiliary battery without the IBS, thereby optimizing the power structure of an electric vehicle, and can reduce the cost by removing the IBS. In addition, an embodiment can also determine whether a dark current problem exists in the vehicle by using the SOC of the auxiliary battery predicted multiple times and provide a notification when it is determined that a dark current problem exists in an electric vehicle.

Further, various effects that can be obtained or expected from embodiments of the present disclosure are directly or suggestively described in the following detailed description. In other words, various effects expected from embodiments of the present disclosure are described in the following detailed description.

### BRIEF DESCRIPTION OF THE DRAWINGS

Hereinafter, embodiments of the present disclosure are described in more detail with reference to the drawings. For clarity, identical parts in different drawings are indicated with the same drawing symbols. It should be noted that the drawings are illustrative only and are not necessarily drawn to scale.

FIG. 1 is a block diagram of an auxiliary battery charge control system of a conventional electric vehicle.

FIG. 2 is a block diagram of an electric vehicle according to an embodiment of the present disclosure.

FIG. 3 illustrates a distribution of charging current values of an auxiliary battery having a SOC of 40% and an auxiliary battery having a SOC of 70% with respect to charging time points of the auxiliary battery, when the ambient temperature 25° C., according to an embodiment of the present disclosure.

FIG. 4 is a flowchart for predicting an SOC of an auxiliary battery of an electric vehicle according to an embodiment of the present disclosure.

### DETAILED DESCRIPTION

Hereinafter, embodiments of the present disclose are described in detail, these embodiments are implemented based on the technical solution of the present disclosure, and disclose detailed embodiments and specific operation processes, but the protection scope of the present disclosure is not limited to the following embodiments.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

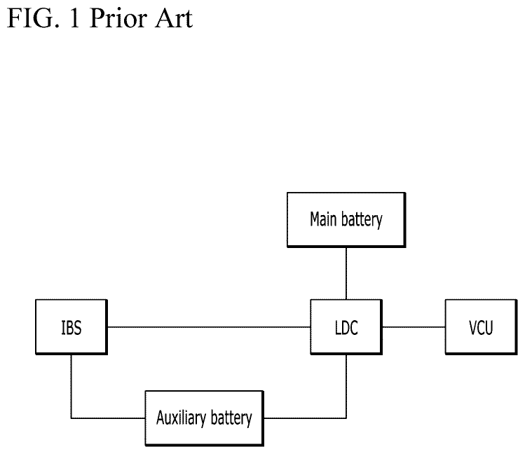

FIG. 1 is a block diagram of an auxiliary battery charge control system of a conventional electric vehicle. As shown in FIG. 1, the auxiliary battery charge control system of a conventional electric vehicle may include a vehicle control unit (VCU), low-voltage DC (direct current)-DC converter (LDC), an intelligent battery sensor (IBS), a main battery and the auxiliary battery.

The IBS may monitor a state of the auxiliary battery, and the state of the auxiliary battery may include a charging current, a charging voltage, a temperature, a state-of-charge (SOC), a state-of-function (SOF) and a state-of-health (SOH), or the like.

The IBS transmits the monitored state of the auxiliary battery to the VCU. The VCU may determine whether to charge the auxiliary battery based on the received state of the auxiliary battery. For example, when the SOC of the auxiliary battery is smaller than or equal to 80%, the VCU may determine to charge the auxiliary battery, and when the charging current of the auxiliary battery is smaller than 1 A or when the SOC of the auxiliary battery is greater than or equal to 92%, the VCU may determine not to charge the auxiliary battery. When charging the auxiliary battery, the LDC may convert a high voltage power of the main battery of the vehicle into a low voltage power, and the converted low voltage power may be provided to the auxiliary battery in order to charge the auxiliary battery.

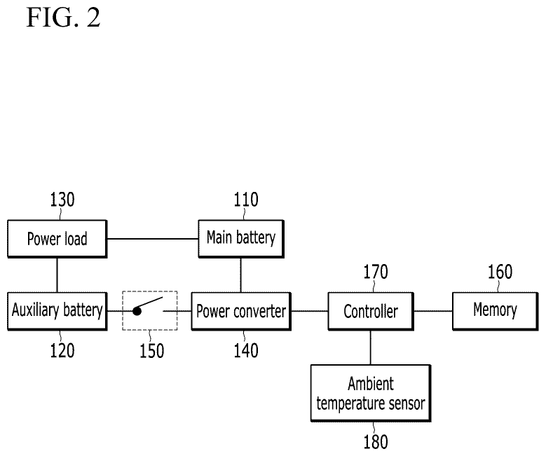

FIG. 2 is a block diagram of an electric vehicle according to an embodiment. As shown in FIG. 2, an electric vehicle according to an embodiment may include a main battery 110, an auxiliary battery 120, a power load 130, a power converter 140, a switch 150, a memory 160 and a controller 170.

The power converter 140 may be electrically connected between the main battery 110 and the auxiliary battery 120, and may be configured to convert the high voltage power outputted from the main battery 110 into the low voltage power. In more detail, the power converter 140 may be a low-voltage DC-DC converter (LDC).

The switch 150 may be electrically connected between the power converter 140 and the auxiliary battery 120. When the switch 150 is turned on, the low voltage power converted in the power converter 140 is provided to the auxiliary battery 120 and the operating power load 130 (i.e., the power load 130 in an operating state), thereby charging the auxiliary battery 120. When the switch 150 is turned off, in order to provide electric power to the operating power load 130, the auxiliary battery 120 is discharged.

In more detail, after the vehicle is turned off (i.e., ignition-off or power-off), the vehicle enters a dormant state, and some of the power loads 130 are woken up in order to secure some vehicle functions and vehicle safety. For example, a charging-related controller, an air adjustment-related controller and a head unit (HU) may maintain a wake-up state, to perform reserved charging or air adjustment. When the switch 150 is turned off, the auxiliary battery 120 may be discharged in order to provide electric power to the power load 130 operating after the vehicle is turned off. When the switch 150 is turned on, the auxiliary battery 120 may receive the low voltage power converted in the power converter 140 and be charged thereby. In addition, the low voltage power converted in the power converter 140 may also be provided to the power load 130 operating after the vehicle is turned off.

The memory 160 may be configured to store the current consumption value I_{A} of the power load 130 operating after the vehicle is turned off. As described above, when the switch 150 is turned on after the vehicle is turned off, the low voltage power converted in the power converter 140 may be provided to the auxiliary battery 120 and the operating power load 130. The output current value I_{c} of the power converter 140 is equal to a sum of the charging current value I_{B} of the auxiliary battery 120 to the current consumption value I_{A} of the operating power load 130. In addition, the current consumption value I_{A} of the power load 130 is basically a fixed value. Therefore, the current consumption value I_{A} of the power load 130 operating after the vehicle is turned off may be obtained in advanced and stored in the memory 160.

The current consumption value I_{A} of the power load 130 operating after the vehicle is turned off may be determined by multiple tests on the vehicle. In more detail, in the test, the low voltage power converted in the power converter 140 after the vehicle is turned off may be provided to the auxiliary battery 120 and the operating power load 130. In each test, the output current value I_{C}_{ᵢ} of the power converter 140 is monitored, the charging current value I_{B}_{ᵢ} of the auxiliary battery 120 is detected, and a difference value of the monitored output current value I_{C}_{ᵢ} of the power converter 140 and the detected charging current value I_{B}_{ᵢ} of the auxiliary battery 120 is taken as the current consumption value I_{A}_{ᵢ} of the power load 130. The output current value I_{C}_{ᵢ} of monitoring and detection of the charging current value I_{B}_{ᵢ} of the auxiliary battery 120 of the power converter 140 may be implemented through an external sensor connected to the vehicle. After performing the multiple tests, an average value of the multiple-times tested current consumption values I_{A}_{ᵢ} of the power load 130 is calculated. Therefore, when the calculated average value is taken as the current consumption value I_{A} of the power load 130 operating after the vehicle is turned off, and stored in the memory 160, the current consumption value I_{A} of the power load 130 operating after the vehicle is turned off stored in the memory 160 can be calculated through the Equation below.

$${I}_{A} = \frac{{\sum }_{i = 1}^{n} ( {I}_{{C}_{i}} - {I}_{{B}_{i}} )}{n}$$

In the Equation above, I_{A} is a current consumption value of the power load operating after the vehicle is turned off that is stored in the memory 160, and I_{C}_{ᵢ} is an output current value of the power converter 140 in an i-th test, and I_{B}_{ᵢ} is a charging current value of the auxiliary battery 120 in the i-th test, and n is the number of times of tests, and for example, 10 times.

In addition, the memory 160 may be configured to store a correspondence relationship between the output current value I_{c} of the power converter 140 and an SOC of the auxiliary battery 120 at the time when the auxiliary battery 120 is charged after the vehicle is turned off. The correspondence relationship is determined by adding the charging current value I_{B} of the auxiliary battery 120 at different SOCs and the current consumption value I_{A} of the power load 130 operating after the vehicle is turned off.

As described above, when the switch 150 is turned on (i.e., when the auxiliary battery 120 is charged) after the vehicle is turned off, the output current value I_{c} of the power converter 140 is equal to a grand total of the charging current value I_{B} of the auxiliary battery 120 and the current consumption value I_{A} of the operating power load 130. Therefore, when the charging current values I_{B} of the auxiliary battery at different SOCs are obtained, the output current value I_{c} of the power converter 140 at each SOC may be obtained by adding the current consumption value I_{A} of the power load 130 and the charging current value I_{B} of the auxiliary battery 120 at each SOC, and by this, a correspondence relationship between the output current value I_{c} of the power converter 140 and the SOC of the auxiliary battery 120 may be obtained.

According to an embodiment of the present disclosure, the correspondence relationship may be a mapping curve corresponding to a first mapping table (which represents a mapping relationship between the output current value I_{C}^{T} of the power converter 140, and the SOC of the auxiliary battery 120 and an ambient temperature, at a specific charging time point T of the auxiliary battery 120 when the auxiliary battery 120 is charged after the vehicle is turned off). In addition, the output current value I_{C}^{T} of the power converter 140 at a specific charging time point T of the auxiliary battery 120 when the auxiliary battery 120 is charged after the vehicle is turned off in the first mapping table may be obtained by adding the charging current value I_{B}^{T} at the specific charging time point T of the auxiliary battery 120 at the same SOC of the auxiliary battery 120 and the same ambient temperature in a second mapping table (which represents a mapping relationship between the output current value, and the SOC of the auxiliary battery 120 and the ambient temperature, at the specific charging time point T of the auxiliary battery 120), and the consumption current I_{A} of the power load 130 operating after the vehicle is turned off stored in the memory 160. Hereinafter, the process of determining the correspondence relationship in an embodiment of the present disclosure is described in detail.

First, a mapping table (i.e., the second mapping table) that represents a mapping relationship between the charging current value I_{B}^{T}, and the SOC and the ambient temperature, at the specific charging time point T of the auxiliary battery 120 may be constructed. The process of constructing the second mapping table includes preparing the auxiliary batteries 120 at different SOCs, i.e., 40%, 50%, 60%, 70%, 80%, and 90%, respectively. Specifically, the auxiliary batteries 120 may be new batteries that have been produced since less than one month (i.e., less than one month old) and have not been used at all. By charging these auxiliary batteries 120, and discharging the auxiliary batteries 120 after being completely charged, the auxiliary batteries 120 of different SOCs can be prepared. For example, the auxiliary battery 120 having an SOC of 90% may be obtained after discharging for 2 hours, and the auxiliary battery 120 having an SOC of 80% may be obtained after discharging for 4 hours. After preparing the auxiliary batteries 120 of different SOCs, the auxiliary batteries 120 of different SOCs is placed at different ambient temperatures for a preset period of time. For example, the ambient temperature may be −20° C., −15° C., −10° C., −5° C., 5° C., 10° C., and 25° C. As an example, the auxiliary battery 120 having an SOC of 90% is placed in the ambient temperature of −20° C., −15° C., −10° C., −5° C., 5° C., 10° C., and 25° C., respectively, for 16 hours, and the same manipulation is applied to the auxiliary batteries 120 of other SOCs. The auxiliary batteries 120 with different SOCs and having been placed in different ambient temperatures is applied with a 14.8V voltage, a 120 A current to charge them, and the charging current values of the auxiliary batteries 120 are monitored.

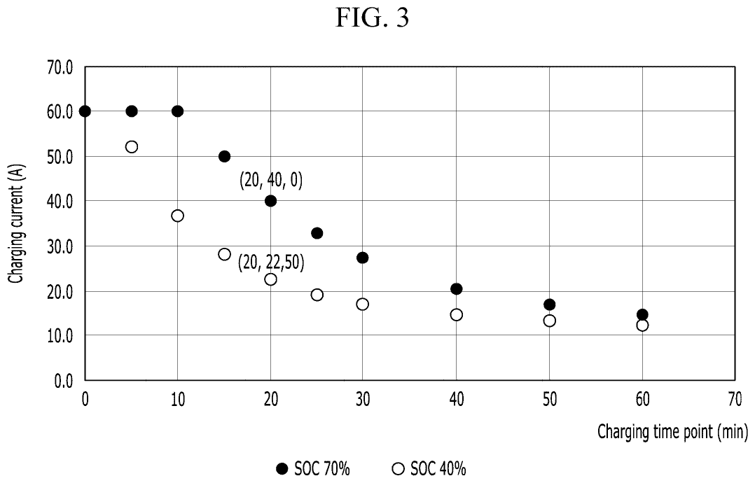

As an example, FIG. 3 illustrates a distribution of the charging current values of the auxiliary battery 120 having the SOC of 40% and the auxiliary battery 120 having the SOC of 70% with respect to charging time points of the auxiliary battery 120, when the ambient temperature is 25° C. As shown in FIG. 3, when a battery is charged by a fixed voltage under a stable environmental condition, the charging current value may decrease according to the flow of time, and the charging current value is not stably maintained at specific fixed value. Therefore, when charging condition does not vary, the battery is charged fast due to the large charging current in the early stage, and charged slow due to the small charging current in the later stage.

When the charging time point T of the auxiliary battery 120 is 20 min, the charging current value of the auxiliary battery 120 having the SOC of 70% may be 22.5 A, and the charging current value of the auxiliary battery 120 having the SOC of 40% may be 40 A. The monitored charging current value (e.g., 40 A and 22.5 A) of the auxiliary battery 120 may be recorded in the second mapping table. Similarly, the charging current values of the auxiliary battery 120 of other SOCs at the same charging time point at other ambient temperatures are recorded in the second mapping table.

Table 1 below represents a mapping table (i.e., the second mapping table) that represents the mapping relationship between the charging current value I_{B}^{T} and the SOC of the auxiliary battery 120 and the ambient temperature, at the specific charging time point T of the auxiliary battery 120. The charging current value I_{B}^{T} at the specific charging time point T of the auxiliary battery 120 is recorded in Table 1. In more detail, as shown in Table 1, the charging current values

$${I}_{B}^{1} , {I}_{B}^{2} , ... ... , {I}_{B}^{41} , and {I}_{B}^{42}$$

of the auxiliary battery 120 are recorded.

TABLE 1

| Ambient | SOC | | | | | |
|---|---|---|---|---|---|---|
| temperature | 40% | 50% | 60% | 70% | 80% | 90% |
| −20° C. | ${I}_{B}^{1}$ | ${I}_{B}^{2}$ | ${I}_{B}^{3}$ | ${I}_{B}^{4}$ | ${I}_{B}^{5}$ | ${I}_{B}^{6}$ |
| −15° C. | ${I}_{B}^{7}$ | ${I}_{B}^{8}$ | ${I}_{B}^{9}$ | ${I}_{B}^{10}$ | ${I}_{B}^{11}$ | ${I}_{B}^{12}$ |
| −10° C. | ${I}_{B}^{13}$ | ${I}_{B}^{14}$ | ${I}_{B}^{15}$ | ${I}_{B}^{16}$ | ${I}_{B}^{17}$ | ${I}_{B}^{18}$ |
| −5° C. | ${I}_{B}^{19}$ | ${I}_{B}^{20}$ | ${I}_{B}^{21}$ | ${I}_{B}^{22}$ | ${I}_{B}^{23}$ | ${I}_{B}^{24}$ |
| 5° C. | ${I}_{B}^{25}$ | ${I}_{B}^{26}$ | ${I}_{B}^{27}$ | ${I}_{B}^{28}$ | ${I}_{B}^{29}$ | ${I}_{B}^{30}$ |
| 10° C. | ${I}_{B}^{31}$ | ${I}_{B}^{32}$ | ${I}_{B}^{33}$ | ${I}_{B}^{34}$ | ${I}_{B}^{35}$ | ${I}_{B}^{36}$ |
| 25° C. | ${I}_{B}^{37}$ | ${I}_{B}^{38}$ | ${I}_{B}^{39}$ | ${I}_{B}^{40}$ | ${I}_{B}^{41}$ | ${I}_{B}^{42}$ |

According to the example of FIG. 3, 40 A and 22.5 A may be recorded in Table 1. In more detail,

$${I}_{B}^{37} = 40 A , and {I}_{B}^{40} = 22.5 A .$$

At this time, the specific charging time point T corresponding to the second mapping table represented in Table 1 may be 20 min. However, the present disclosure is not limited to selecting the specific charging time point T of the auxiliary battery 120 as 20 min, and the specific charging time point T may be selected as 5 min, 10 min, 15 min, or the like. According to the conventional data analysis, when a battery is charged under the same charging condition, the difference of the charging current value is maximum at a time band of 5 min to 30 min, and the SOC of the battery may be most easily distinguished by comparing the magnitude of the battery charging current value in this time band. Therefore, the value of the specific charging time point T may be 5 min to 30 min. Therefore, Table 1 in which different data are recorded can be obtained.

In an embodiment of the present disclosure, when the second mapping table is constructed by selecting one specific charging time point, the SOC of the auxiliary battery can be predicted, thereby saving the logic and simplifying the algorithm.

After obtaining the second mapping table, by adding each of the charging current values

$${I}_{B}^{1} , {I}_{B}^{2} , ... , ... , {I}_{B}^{41} , and {I}_{B}^{42}$$

and the consumption current I_{A} of the power load 130 operating after the vehicle is turned off stored in the memory 160, the output current value I_{C}^{T} at the specific charging time point of the auxiliary battery 120 of the power converter 140 when the auxiliary battery 120 is charged after the vehicle is turned off can be obtained. Therefore, by combining the SOC of the auxiliary battery 120 and the ambient temperature, the first mapping table representing a mapping relationship between the output current value I_{C}^{T} of the power converter 140, and the SOC of the auxiliary battery 120 and the ambient temperature, at the specific charging time point T of the auxiliary battery 120 when the auxiliary battery 120 is charged after the vehicle is turned off is constructed.

Table 2 below represents a mapping table (i.e., the first mapping table) representing the mapping relationship between the output current value I_{C}^{T} of the power converter 140, and the SOC of the auxiliary battery 120 and the ambient temperature, at the specific charging time point T of the auxiliary battery 120 when the auxiliary battery 120 is charged after the vehicle is turned off.

TABLE 2

| Ambient | SOC | | | | | |
|---|---|---|---|---|---|---|
| temperature | 40% | 50% | 60% | 70% | 80% | 90% |
| −20° C. | ${I}_{C}^{1}$ | ${I}_{C}^{2}$ | ${I}_{C}^{3}$ | ${I}_{C}^{4}$ | ${I}_{C}^{5}$ | ${I}_{C}^{6}$ |
| −15° C. | ${I}_{C}^{7}$ | ${I}_{C}^{8}$ | ${I}_{C}^{9}$ | ${I}_{C}^{10}$ | ${I}_{C}^{11}$ | ${I}_{C}^{12}$ |
| −10° C. | ${I}_{C}^{13}$ | ${I}_{C}^{14}$ | ${I}_{C}^{15}$ | ${I}_{C}^{16}$ | ${I}_{C}^{17}$ | ${I}_{C}^{18}$ |
| −5° C. | ${I}_{C}^{19}$ | ${I}_{C}^{20}$ | ${I}_{C}^{21}$ | ${I}_{C}^{22}$ | ${I}_{C}^{23}$ | ${I}_{C}^{24}$ |
| 5° C. | ${I}_{C}^{25}$ | ${I}_{C}^{26}$ | ${I}_{C}^{27}$ | ${I}_{C}^{28}$ | ${I}_{C}^{29}$ | ${I}_{C}^{30}$ |
| 10° C. | ${I}_{C}^{31}$ | ${I}_{C}^{32}$ | ${I}_{C}^{33}$ | ${I}_{C}^{34}$ | ${I}_{C}^{35}$ | ${I}_{C}^{36}$ |
| 25° C. | ${I}_{C}^{37}$ | ${I}_{C}^{38}$ | ${I}_{C}^{39}$ | ${I}_{C}^{40}$ | ${I}_{C}^{41}$ | ${I}_{C}^{42}$ |

The output current value I_{C}^{T} at the specific charging time point T of the auxiliary battery 120 of the power converter 140 when the auxiliary battery 120 is charged after the vehicle is turned off in the first mapping table may be obtained by adding the charging current value I_{B}^{T} at the specific charging time point T of the auxiliary battery 120 at the same SOC of the auxiliary battery 120 and the same ambient temperature in the second mapping table, and the consumption current I_{A} of the power load 130 operating after the vehicle is turned off stored in the memory 160. In more detail, as shown in Table 2, the output current values

$${I}_{C}^{1} , {I}_{C}^{2} , ... ... , {I}_{C}^{41} , and {I}_{C}^{42}$$

of the power converter 140 may be calculated through the Equations below.

$${I}_{C}^{1} = {I}_{B}^{1} + {I}_{A} ;$$

$${I}_{C}^{2} = {I}_{B}^{2} + {I}_{A} ;$$

$${I}_{C}^{3} = {I}_{B}^{3} + {I}_{A} ;$$

$$... ...$$

$${I}_{C}^{41} = {I}_{B}^{41} + {I}_{A} ;$$

$${I}_{C}^{42} = {I}_{B}^{42} + {I}_{A} .$$

Afterwards, a mapping curve corresponding to the first mapping table may be drawn according to data shown in Table 2. In more detail, a coordinate system is created, each of 3 axis directions of the coordinate system is perpendicular to a plane formed by 2 axes other than that, the three coordinate axes are set as X-axis, Y-axis, and Z-axis, respectively, the ambient temperature is set as the X-axis, the output current value I_{C}^{T} at the specific charging time point T of the auxiliary battery 120 of the power converter 140 when the auxiliary battery 120 is charged after the vehicle is turned off is set as the Y-axis, and the SOC of the auxiliary battery 120 is set as the Z-axis. Through this, the data of Table 2 may be converted into a plurality of coordinate points

$$( - 20 , {I}_{C}^{1} , 40 ) , ( - 20 , {I}_{C}^{2} , 50 ) , ( - 20 , {I}_{C}^{3} , 60 ) , ... ... , \\ ( 25 , {I}_{C}^{40} , 40 ) , ( 25 , {I}_{C}^{41} , 40 ) , ( 25 , {I}_{C}^{42} , 40 ) .$$

Based on these coordinate points, the mapping curve in the coordinate system may be fitted to correspond to the first mapping table, and the mapping curve may be used as a correspondence relationship between the output current value I_{C} of the power converter 140 and the SOC of the auxiliary battery 120 at the time when the auxiliary battery is charged after the vehicle is turned off, and stored in the memory 160.

According to an embodiment, the controller 170 (e.g., a vehicle control unit (the VCU)) may control turning on or off of the switch 150 after the vehicle is turned off, to control charging of the auxiliary battery 120. In more detail, the controller 170 may control turning on of the switch 150 according to an elapsed time, and may control turning off of the switch 150 according to the calculated charging current value

$${I}_{B}^{0}$$

or the auxillary battery 120 and the predicted SOC of the auxiliary battery 120.

As described above, when the switch 150 is turned off after the vehicle is turned off, the auxiliary battery 120 supplies electric power to the power load 130 operating at this time, and the discharging of the auxiliary battery 120 may decrease the SOC of the auxiliary battery 120. In order to prevent the electric power of the auxiliary battery 120 from being completely consumed, the controller 170 may operate a timer after the vehicle is turned off. When a first reference time has elapsed after the vehicle is turned off, (e.g., 30 min, but not limited thereto), the controller 170 may control the switch to be turned on, to provide the low voltage power (e.g., 14.8V power) converted in the power converter 140 to the auxiliary battery 120, and the charging of the auxiliary battery 120 may increase the SOC of the auxiliary battery 120.

Until the predicted SOC of the auxiliary battery 120 is greater than or equal to a reference power threshold value (e.g., 92%), or the calculated charging current value

$${I}_{B}^{0}$$

of the auxillary battery 120 is smaller than a reference current threshold value (e.g., 1 A), the controller 170 may control the switch 150 to be turned off. When the SOC of the auxiliary battery 120 is 92% or more, and the charging current value

$${I}_{B}^{0}$$

of the auxillary battery 120 is smaller than 1 A, each of these means that the auxiliary battery 120 is charged almost completely, and the charging of the auxiliary battery 120 may be stopped.

After the controller 170 controls the switch to be turned off, the controller 170 may control the switch 150 to be turned on at an interval of a second reference time (e.g., 2 h or 3 h, but not limited thereto). In the same way, until the predicted SOC of the auxiliary battery 120 is greater than or equal to the reference power threshold value, or the calculated charging current value

$${I}_{B}^{0}$$

of the auxiliary battery 120 is smaller than the reference current threshold value, the controller 170 may control the switch 150 to be turned off. In other words, the auxiliary battery 120 may be periodically charged, and one cycle of charging is completed only after the auxiliary battery 120 is charged almost completely.

When the auxiliary battery is charged after the vehicle is turned off, the controller 170 may obtain the output current value I_{C} of the power converter.

When calculating the charging current value

$${I}_{B}^{0}$$

of the auxillary battery 120, the controller 170 may obtain the output current value

$${I}_{C}^{0}$$

of the power converter 140 in real time when the auxiliary battery is charged after the vehicle is turned off. Therefore, the charging current value

$${I}_{C}^{0}$$

of the auxiliary battery 120 is equal to a difference value between the output current value

$${I}_{C}^{0}$$

of the power converter 140 obtained in real time by the controller 170, and the current consumption value I_{A} of the power load 130 operating after the vehicle is turned off that is stored in the memory 160. For example, the controller 170 may determine whether the calculated charging current value

$${I}_{B}^{0}$$

of the auxiliary battery 120 is smaller than 1 A, and when it is determined that the calculated charging current value

$${I}_{B}^{0}$$

of the auxiliary battery 120 is smaller than 1 A, the controller 170 may control the switch 150 to be turned off.

When predicting the SOC of the auxiliary battery 120, the controller 170 may obtain the output current value I_{C}^{T} of the power converter 140 at each specific charging time point T of charging the auxiliary battery 120. For example, according to the example of FIG. 3, when the charging time point T is 20 min, the controller 170 obtains the output current value I_{C}^{T} of the power converter 140 at each 20 min of charging the auxiliary battery 120. For example, the output current value of the power converter 140 obtained by the controller 170 is I_{C}^{T}^{⁰}.

According to an embodiment, the controller 170 may determine the SOC of the auxiliary battery 120, based on the obtained output current value I_{c} of the power converter 140, according to the correspondence relationship stored in the memory 160. Therefore, in an embodiment, although an intelligent battery sensor (IBS) is not installed in the vehicle, the SOC of the auxiliary battery 120 after the vehicle is turned off can be predicted.

In an embodiment, since the mapping curve relates to the ambient temperature, the controller also needs to obtain the ambient temperature. Through this, referring back to FIG. 2, the electric vehicle may further include an ambient temperature sensor 180. The ambient temperature sensor 180 may be configured to detect the ambient temperature outside the vehicle at each specific charging time point T of charging the auxiliary battery 120. For example, the ambient temperature detected by the ambient temperature sensor is Tep⁰.

Since the vehicle according to an embodiment is without the IBS, the controller 170 cannot measure the temperature of the auxiliary battery 120 (i.e., an internal temperature of the auxiliary battery 120) by using the conventional IBS. Instead, the controller 170 detects the ambient temperature through the ambient temperature sensor 180 mounted outside the vehicle. Correspondingly, each temperature in the first mapping table and the second mapping table also refers to the ambient temperature. In general, the internal temperature of the auxiliary battery 120 is greater than or equal to the ambient temperature outside the vehicle. Currently, the estimated tolerance of the SOC of the auxiliary battery 120 of the IBS is ±10%, and the estimated tolerance of the temperature of the auxiliary battery 120 is ±6%. In an embodiment, the influence of the ambient temperature on the construction of the second mapping table is not large, so it is determined that the error of an embodiment is within an allowable range.

In addition, according as the X-axis coordinate is Tep⁰, and the Y-axis coordinate is I_{C}^{T}^{⁰}, one coordinate point on the mapping curve may be determined, and since a numerical value on the Z-axis corresponding to the coordinate point is the predicted SOC of the auxiliary battery 120, the SOC of the auxiliary battery 120 can be predicted without installing the IBS in the vehicle.

The controller 170 may determine whether the SOC of the auxiliary battery 120 is smaller than 92%, and when it is determined that the SOC of the auxiliary battery 120 is greater than or equal to 92%, the controller 170 may control the switch 150 to be turned off. While 92% is used in this example, other threshold examples may be used.

Through an embodiment of the present disclosure, the SOC of the auxiliary battery after the vehicle is turned off can be predicted, but the situation differs after the vehicle is turned on (i.e., ignition-on or power-on). According to an embodiment, since the controller 170 may force the switch 150 to maintain the turned-on state after the turning on of the vehicle, the low voltage power (e.g., 14V) converted in the power converter 140 is continuously provided to the auxiliary battery 120, and the auxiliary battery 120 is continuously charged without the need to predict the SOC of the auxiliary battery 120. Therefore, compared to the conventional IBS that always monitors the SOC of the auxiliary battery 120, the control logic of the vehicle can be saved.

In summary, the controller 170 may perform prediction of the SOC of the auxiliary battery 120 for each period of charging the auxiliary battery 120, and the auxiliary battery 120 may be periodically charged. During the paring after the vehicle is turned off, the controller 170 may predict the SOC of the auxiliary battery 120 multiple times. According to an embodiment, the controller 170 may determine whether a dark current problem has occurred in an electric vehicle by using the multiple-times predicted SOC of the auxiliary battery 120.

In more detail, after the vehicle is turned off, the controller 170 may set a dark current amount Issue_Num to be 0. The controller 170 may calculate a difference value of the SOC of the auxiliary battery 120 predicted twice consecutively through the Equation below.

$$D = {SOC}_{m - 1} - {SOC}_{m}$$

In the Equation above, D is a difference value, SOCₘ₋₁ is a previously predicted SOC of the auxiliary battery 120, SOCₘ is a currently predicted SOC of the auxiliary battery 120, and m is an integer greater than or equal to 2.

The controller 170 may determine whether a difference value D is greater than or equal to a reference value, and when it is determined that the difference value D is greater than or equal to the reference value (e.g., 10%), this means that the dark current exists, and accordingly, the controller 170 may increase the dark current amount Issue_Num by 1. When it is determined that the difference value D is smaller than the reference value (e.g., 10%), this means that the dark current does not exist, and accordingly, the controller 170 may maintain the dark current amount Issue_Num not to vary.

When the accumulate the dark current amount Issue_Num is greater than or equal to a reference dark current amount threshold value (e.g., 2), the controller 170 may determine that the dark current problem has occurred. Additionally, after determining that the dark current problem has occurred

by the controller 170, the controller 170 generates a diagnostic trouble code (DTC), and transmit the DTC to the display device, to be finally displayed thereon, thereby notifying it to the driver. In more detail, the display device may be a cluster or a part of Connected Car Navigation Cockpit (CNCC), of the vehicle. In addition, the DTC may be recorded in a power data center (PDC).

An embodiment further provides a method for predicting an SOC of an auxiliary battery of an electric vehicle, and an applied electric vehicle has the configuration of the electric vehicle shown in FIG. 2.

A method for predicting the SOC of the auxiliary battery 120 of an electric vehicle includes: controlling, charging of the auxiliary battery 120 by controlling the turning on or off of the switch 150 by the controller 170, after the vehicle is turned off; obtaining the output current value of the power converter by the controller 170, when the auxiliary battery 120 is charged after the vehicle is turned off; storing the current consumption value of the power load operating after the vehicle is turned off and a correspondence relationship between the output current value of the power converter at the time when the auxiliary battery 120 is charged after the vehicle is turned off and the SOC of the auxiliary battery 120, by the memory 160, where, the correspondence relationship is determined by adding the charging current value of the auxiliary battery 120 at different SOCs and the current consumption value of the power load operating after the vehicle is turned off; and determining the SOC of the auxiliary battery 120 that can predict the SOC of the auxiliary battery 120 after the vehicle is turned off without installing an intelligent battery sensor in the vehicle, based on the obtained output current value of the power converter, according to the correspondence relationship stored in the memory 160, by the controller 170.

In an embodiment, the controlling of the turning on or off of the switch 150 by the controller 170 after the vehicle is turned off may include controlling the switch 150 to be turned on according to the elapsed time, and controlling turning off of the switch 150 according to the calculated charging current value of the auxiliary battery 120 or the predicted SOC of the auxiliary battery 120.

In more detail, when the first reference time has elapsed after the vehicle is turned off, the switch 150 is controlled to be turned on by the controller 170, and when the predicted SOC of the auxiliary battery 120 satisfies a threshold (i.e., is greater than or equal to the reference power threshold value), or when the calculated charging current value of the auxiliary battery 120 is smaller than the reference current threshold value, the switch 150 is controlled to be turned off, by the controller 170. After controlling the switch 150 to be turned off, at the second reference time interval, the switch 150 is controlled to be turned on by the controller 170, and the switch 150 is controlled to be turned off by the controller 170, when the predicted SOC of the auxiliary battery 120 satisfies a threshold (i.e., is greater than or equal to the reference power threshold value), or when the calculated charging current value of the auxiliary battery 120 is smaller than the reference current threshold value.

The charging current value of the auxiliary battery 120 is equal to a difference value between the output current value of the power converter obtained in real time when the auxiliary battery 120 is charged after the vehicle is turned off by the controller 170 and, the current consumption value of the power load operating after the vehicle is turned off that is stored in the memory 160.

In an embodiment, the current consumption value of the power load operating after the vehicle is turned off stored in the memory 160 may be calculated through the Equation below.

$${I}_{A} = \frac{{\sum }_{i = 1}^{n} ( {I}_{{C}_{i}} - {I}_{{B}_{i}} )}{n}$$

In the Equation above, I_{A} is the current consumption value of the power load operating after the vehicle is turned off that is stored in the memory 160, and I_{C}_{ᵢ} is the output current value of the power converter in the i-th test, and I_{B}_{ᵢ} is the charging current value of the auxiliary battery 120 in the i-th test, and n is the number of times of tests. In the test, the low voltage power converted in the power converter after the vehicle is turned off may be provided to the auxiliary battery 120 and the operating power load.

In an embodiment, the correspondence relationship may be the mapping curve corresponding to the first mapping table, and the first mapping table represents the mapping relationship between the output current value of the power converter, and the SOC of the auxiliary battery 120 and the ambient temperature, at the specific charging time point of the auxiliary battery 120 when the auxiliary battery 120 is charged after the vehicle is turned off.

An output current value at the specific charging time point of the auxiliary battery 120 of the power converter when the auxiliary battery 120 is charged after the vehicle is turned off in the first mapping table is obtained by adding the charging current value at the specific charging time point of the auxiliary battery 120 at the same SOC of the auxiliary battery 120 and the same ambient temperature in the second mapping table, and the current consumption value of the power load operating after the vehicle is turned off stored in the memory 160. The second mapping table represents the mapping relationship between the charging current value, and the SOC of the auxiliary battery 120 and the ambient temperature, at the specific charging time point of the auxiliary battery 120. For example, in the second mapping table, the SOC of the auxiliary battery 120 may include 40%, 50%, 60%, 70%, 80%, and 90%, and the ambient temperature may include −20° C., −15° C., −10° C., −5° C., 5° C., 10° C., and 25° C., and a range of the specific charging time may be 5 min to 30 min.

The electric vehicle further includes the ambient temperature sensor, and the method further includes detecting the ambient temperature outside the vehicle at each specific charging time point of charging the auxiliary battery 120 by the ambient temperature sensor 180; and determining the SOC of the auxiliary battery, on the mapping curve, based on the ambient temperature detected by the ambient temperature sensor 180 at each specific charging time point of charging the auxiliary battery 120 and when the auxiliary battery 120 is charged after the vehicle is turned off, the output current value of the power converter obtained at each specific charging time point of charging the auxiliary battery 120, by the controller 170.

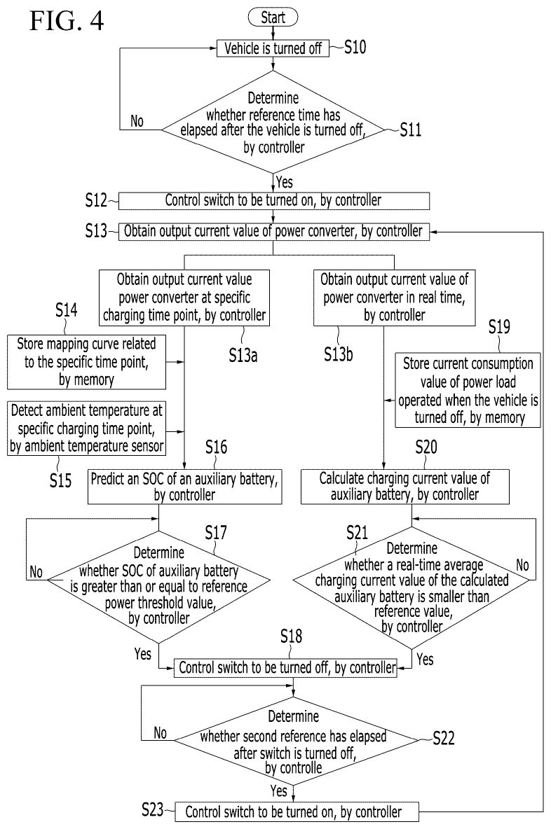

FIG. 4 is a flowchart for predicting the SOC of the auxiliary battery 120 of an electric vehicle according to an embodiment of the present disclosure. As shown in FIG. 4, after the vehicle is turned off at step S10, whether the first reference time has elapsed after the vehicle is turned off is determined, by the controller 170, at step S11. When a first reference elapsed time has elapsed after the vehicle is turned off (“Yes” at the step S11), the switch 150 is controlled to be turned on by the controller 170 at step S12, and thereby the auxiliary battery 120 is charged. After the switch 150 is controlled to be turned on by the controller 170 at step S12, the output current value of the power converter is obtained by the controller 170 at step S13.

The controller 170 obtains the output current value of the power converter at the specific charging time point, at step S13a, and the SOC of the auxiliary battery 120 is predicted by the controller 170 at step S16 based on the mapping curve related to the specific time point stored in the memory 160 at step S14, and the ambient temperature detected by the ambient temperature sensor 180 at the specific charging time point at step S15.

Whether the predicted SOC of the auxiliary battery 120 is greater than or equal to the reference power threshold value is determined by the controller 170 at step S17, and when it is determined that the predicted SOC of the auxiliary battery 120 is greater than or equal to the reference power threshold value (“Yes” at the step S17), the switch 150 is controlled to be turned off by the controller 170 at step S18.

Alternatively, the output current value of the power converter is obtained in real time by the controller 170 at step S13b, and the charging current value of the auxiliary battery 120 is calculated by the controller 170 at step S20, according to the current consumption value of the power load operating after the vehicle is turned off stored in the memory 160 at step S19. Whether the calculated charging current value of the auxiliary battery 120 is smaller than the reference current threshold value is determined, by the controller 170, at step S21. When the calculated charging current value of the auxiliary battery 120 is smaller than the reference current threshold value (“Yes” at the step S21), the switch 150 is controlled to be turned off by the controller 170 at the step S18.

After controlling the switch 150 to be turned off by the controller 170 at the step S18, whether the second reference time has elapsed is determined by the controller 170, at step S22. When the second reference time has elapsed after the switch 150 is turned off (“Yes” at the step S22), the switch 150 is controlled to be turned on, by the controller 170, at step S23. Afterwards, the process returns to the step S13 in order to perform a second prediction of the SOC of the auxiliary battery.

Based on the prediction on the SOC multiple times, a method for predicting the SOC of the auxiliary battery 120 of an electric vehicle may further include setting a dark current amount as 0 after the vehicle is turned off, by the controller 170; and calculating the difference value of SOC of the auxiliary battery predicted twice consecutively through the Equation below, by the controller 170.

$$D = {SOC}_{m - 1} - {SOC}_{m}$$

In the Equation above, D is a difference value, SOCₘ₋₁ is a previously predicted SOC of the auxiliary battery 120, SOCₘ is a currently predicted SOC of the auxiliary battery, and m is an integer greater than or equal to 2.

Based on the prediction on the SOC multiple times, a method for predicting the SOC of the auxiliary battery 120 of an electric vehicle may further include determining whether the difference value is greater than or equal to the reference value, by the controller 170; increasing the dark current amount by 1, by the controller 170, when it is determined that the difference value greater than or equal to the reference value; maintaining the dark current amount not to vary, by the controller 170, when it is determined that the difference value is smaller than the reference value; and determining that the dark current problem has occurred, by the controller 170, when the accumulated dark current amount is greater than or equal to a reference dark current amount threshold value.

After determining that the dark current problem has occurred by the controller 170, the diagnostic trouble code is generated and transmitted by the controller.

After turning off the vehicle, a method for predicting the SOC of the auxiliary battery 120 of an electric vehicle may further include maintaining the switch 150 to be turned on, by the controller 170, so as to continuously charge the auxiliary battery 120 without the need to predict the SOC of the auxiliary battery 120 after the vehicle is turned on.

An electric vehicle and a method for predicting an SOC of an auxiliary battery of an electric vehicle according to an embodiment can predict the SOC of the auxiliary battery without the IBS, thereby optimizing the power structure of an electric vehicle, and can reduce the cost by removing the IBS.

In addition, an electric vehicle and a method for predicting the SOC of the auxiliary battery of an electric vehicle according to an embodiment can determine whether a dark current problem exists in the vehicle by using the SOC of the auxiliary battery predicted multiple times, and provide a notification when it is determined that a dark current problem exists in an electric vehicle.

Various embodiments of the present disclosure may not enumerate all possible combinations, but rather illustrate representative aspects of the present disclosure, and the contents described in the various embodiments may be applied independently or in combination of two or more.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. An electric vehicle, comprising a main battery, an auxiliary battery, a power load, a power converter, a switch, a memory, and a controller,
wherein the power converter is electrically connected between the main battery and the auxiliary battery, and configured to convert a first voltage power outputted from the main battery into a second voltage power,
wherein the switch is electrically connected between the power converter and the auxiliary battery, and configured such that, based on the switch being turned on, the auxiliary battery is charged as the second voltage power converted in the power converter is provided to the auxiliary battery and an operating power load, and based on the switch being turned off, the auxiliary battery is discharged to provide electric power to the operating power load,
wherein the memory is configured to store a current consumption value of the operating power load after the electric vehicle is turned off and a correspondence relationship between an output current value of the power converter and a state-of-charge (SOC) of the auxiliary battery based on the auxiliary battery being charged after the electric vehicle is turned off, and
wherein the controller is configured to:
control the switch after the electric vehicle is turned off to control charging of the auxiliary battery;
obtain the output current value of the power converter, based on the auxiliary battery being charged after the electric vehicle is turned off; and
determine, based on the obtained output current value of the power converter and the correspondence relationship stored in the memory, the SOC of the auxiliary battery after the electric vehicle is turned off.

2. The electric vehicle of claim 1, wherein the controller is further configured to continuously charge the auxiliary battery, by maintaining the switch to be turned on after the electric vehicle is turned on.

3. The electric vehicle of claim 1, wherein:
the controller is further configured to control the switch to be turned on based on an elapsed time, and control turning off the switch based on a calculated charging current value of the auxiliary battery or a predicted SOC of the auxiliary battery; and
the calculated charging current value of the auxiliary battery is equal to a difference value between the output current value of the power converter obtained in real time based on the auxiliary battery being charged after the electric vehicle is turned off and the current consumption value of the operating power load after the electric vehicle is turned off that is stored in the memory.

4. The electric vehicle of claim 3, wherein the controller is further configured to:
control the switch to be turned on based on a first reference time having elapsed after the electric vehicle is turned off;
control the switch to be turned off based on the predicted SOC of the auxiliary battery being greater than or equal to a reference power threshold value, or based on the calculated charging current value of the auxiliary battery being smaller than a reference current threshold value;
control the switch to be turned on at a second reference time interval, after controlling the switch to be turned off; and
control the switch to be turned off, based on the predicted SOC of the auxiliary battery being greater than or equal to the reference power threshold value, or based on the calculated charging current value of the auxiliary battery being smaller than the reference current threshold value.

5. The electric vehicle of claim 1, wherein:
the current consumption value of the operating power load after the electric vehicle is turned off stored in the memory is obtained through a test; and
in the test, the second voltage power converted by the power converter after the electric vehicle is turned off is provided to the auxiliary battery and the operating power load.

6. The electric vehicle of claim 1, wherein:
the correspondence relationship is a mapping curve corresponding to a first mapping table, and the first mapping table represents a mapping relationship between the output current value of the power converter, and the SOC of the auxiliary battery and an ambient temperature, at a specific charging time point of the auxiliary battery based on the auxiliary battery being charged after the electric vehicle is turned off;
the electric vehicle further comprises an ambient temperature sensor configured to detect the ambient temperature outside the electric vehicle at each specific charging time point of charging the auxiliary battery; and
the controller is further configured to determine the SOC of the auxiliary battery on the mapping curve, based on the ambient temperature detected by the ambient temperature sensor at each specific charging time point of charging the auxiliary battery and the output current value of the power converter obtained at each specific charging time point of charging the auxiliary battery based on the auxiliary battery being charged after the electric vehicle is turned off.

7. The electric vehicle of claim 6, wherein:
the output current value of the power converter at the specific charging time point of the auxiliary battery based on the auxiliary battery being charged after the electric vehicle is turned off in the first mapping table is obtained by adding a charging current value at the specific charging time point of the auxiliary battery at a same SOC of the auxiliary battery and a same ambient temperature in a second mapping table, and the current consumption value of the operating power load after the electric vehicle is turned off stored in the memory; and
the second mapping table represents a mapping relationship between the charging current value, and the SOC of the auxiliary battery and the ambient temperature at the specific charging time point of the auxiliary battery.

8. The electric vehicle of claim 7, wherein, in the second mapping table, a range of the SOC of the auxiliary battery is a predetermined first SOC value to a predetermined second SOC value, a range of the ambient temperature is a predetermined first ambient temperature value to a predetermined second ambient temperature value, and a range of the specific charging time is a predetermined first charging time value to a predetermined second charging time value.

9. The electric vehicle of claim 1, wherein the controller is further configured to:
set a dark current amount to be 0, after the electric vehicle is turned off;
obtain a difference value between values of the SOC of the auxiliary battery predicted twice consecutively;
determine whether the difference value is greater than or equal to a reference value;
increase the dark current amount by 1 based on determining that the difference value is greater than or equal to the reference value;
maintain the dark current amount not to vary based on determining that the difference value is smaller than the reference value; and
determine that a dark current problem has occurred, based on an accumulated dark current amount being greater than or equal to a reference dark current amount threshold value.

10. The electric vehicle of claim 9, wherein the controller is further configured to generate and transmit a diagnostic trouble code, based on determining that the dark current problem has occurred.

11. A method for predicting a state-of-charge (SOC) of an auxiliary battery of an electric vehicle, the electric vehicle comprising a main battery, the auxiliary battery, a power converter, a switch, a memory and a controller, the power converter being electrically connected between the main battery and the auxiliary battery, and the switch being electrically connected between the power converter and the auxiliary battery, the method comprising:
controlling charging of the auxiliary battery, by controlling, by the controller, the switch, after the electric vehicle is turned off;
storing, by the memory, a current consumption value of an operating power load after the electric vehicle is turned off and a correspondence relationship between an output current value of the power converter and the SOC of the auxiliary battery based on the auxiliary battery being charged after the electric vehicle is turned off;
obtaining, by the controller, the output current value of the power converter based on the auxiliary battery being charged after the electric vehicle is turned off; and
determining, by the controller, the SOC of the auxiliary battery after the electric vehicle is turned off, based on the obtained output current value of the power converter and the correspondence relationship stored in the memory.

12. The method of claim 11, further comprising continuously charging the auxiliary battery by maintaining the switch to be turned on, by the controller, after turning of the electric vehicle.

13. The method of claim 11, wherein controlling, by the controller, the switch after the electric vehicle is turned off comprises:
controlling the switch to be turned on based on an elapsed time; and
controlling turning off of the switch based on a calculated charging current value of the auxiliary battery or a predicted SOC of the auxiliary battery,
wherein the calculated charging current value of the auxiliary battery is equal to a difference value between the output current value of the power converter obtained in real time based on the auxiliary battery being charged after the electric vehicle is turned off and the current consumption value of the operating power load after the electric vehicle is turned off that is stored in the memory.

14. The method of claim 13, wherein controlling, by the controller, the switch after the electric vehicle is turned off further comprises:
controlling, by the controller, the switch to be turned on based on a first reference time having elapsed after the electric vehicle is turned off;
controlling, by the controller, the switch to be turned off based on the predicted SOC of the auxiliary battery being greater than or equal to a reference power threshold value, or based on the calculated charging current value of the auxiliary battery being smaller than a reference current threshold value;
controlling the switch to be turned on at a second reference time interval, after controlling the switch to be turned off; and
controlling the switch to be turned off, based on the predicted SOC of the auxiliary battery being greater than or equal to the reference power threshold value, or based on the calculated charging current value of the auxiliary battery being smaller than the reference current threshold value, by the controller.

15. The method of claim 11, wherein:
the current consumption value of the operating power load after the electric vehicle is turned off stored in the memory can be obtained through a test; and
in the test, a voltage power converted by the power converter after the electric vehicle is turned off is provided to the auxiliary battery and the operating power load.

16. The method of claim 11, wherein,
the correspondence relationship is a mapping curve corresponding to a first mapping table, the first mapping table representing a mapping relationship between the output current value of the power converter, and the SOC of the auxiliary battery and an ambient temperature, at a specific charging time point of the auxiliary battery based on the auxiliary battery being charged after the electric vehicle is turned off, and wherein the electric vehicle further comprises an ambient temperature sensor, and
wherein the method further comprises:
detecting, by the ambient temperature sensor, the ambient temperature outside the electric vehicle at each specific charging time point of charging the auxiliary battery; and
determining, by the controller, the SOC of the auxiliary battery on the mapping curve, based on the ambient temperature detected by the ambient temperature sensor at each specific charging time point of charging the auxiliary battery and the output current value of the power converter obtained at each specific charging time point of charging the auxiliary battery based on the auxiliary battery being charged after the electric vehicle is turned off.

17. The method of claim 16, wherein:
the output current value of the power converter at the specific charging time point of the auxiliary battery based on the auxiliary battery being charged after the electric vehicle is turned off in the first mapping table is obtained by adding a charging current value at the specific charging time point of the auxiliary battery at a same SOC of the auxiliary battery and a same ambient temperature in a second mapping table, and the current consumption value of the operating power load after the electric vehicle is turned off stored in the memory; and
the second mapping table represents a mapping relationship between the charging current value, and the SOC of the auxiliary battery and the ambient temperature, at the specific charging time point of the auxiliary battery.

18. The method of claim 17, wherein, in the second mapping table, a range of the SOC of the auxiliary battery is a predetermined first SOC value to a predetermined second SOC value, a range of the ambient temperature is a predetermined first ambient temperature value to a predetermined second ambient temperature value, and a range of the specific charging time is a predetermined first charging time value to a predetermined second charging time value.

19. The method of claim 11, further comprising:
setting, by the controller, a dark current amount to be 0, after the electric vehicle is turned off;
obtaining a difference value between values of the SOC of the auxiliary battery predicted twice consecutively;
determining, by the controller, whether the difference value is greater than or equal to a reference value;
increasing, by the controller, the dark current amount by 1 based on determining that the difference value is greater than or equal to the reference value;
maintaining, by the controller, the dark current amount not to vary based on determining that the difference value is smaller than the reference value; and
determining, by the controller, that a dark current problem has occurred based on an accumulated dark current amount being greater than or equal to reference dark current amount threshold value.

20. The method of claim 19, further comprising generating and transmitting a diagnostic trouble code, by the controller, based on determining that the dark current problem has occurred.
